(19) United States
(12) Patent Application Publication
(10) Pub. No.: US 2013/0128860 A1
(43) Pub. Date: May 23, 2013

(54) Methods and Systems for CSI-RS Resource Allocation in LTE-Advance Systems

(71) Applicant: Wenfeng Zhang, Plano, TX (US)

(72) Inventor: Wenfeng Zhang, Plano, TX (US)

(21) Appl. No.: 13/701,475

(22) PCT Filed: Jun. 1, 2011
(86) PCT No.: PCT/US11/38794

§ 371 Date: Feb. 6, 2013

Related U.S. Application Data
(60) Provisional application No. 61/350,432, filed on Jun. 1, 2010.

(51) Int. Cl. H04W 72/04

(52) U.S. Cl. CPC H04W 72/04
USPC 370/330; 370/329

(57) ABSTRACT

A method of allocating resource elements in an orthogonal frequency division multiplexed (OFDM) system for transmission of a channel state information reference signal (CSI-RS) without overlapping with resource elements allocated to a port-5 user equipment-specific reference signal (URS) signal is disclosed. The method can include shifting in a frequency domain at least a portion of resource elements allocated to the CSI-RS in a normal-CP subframe. According to certain embodiments, the allocation of resource elements can be defined per an 8-port CSI-RS, or per a group of eight CSI-RS resource elements, within a single physical resource block (PRB) whose time-domain dimension is one subframe and whose frequency-domain dimension is 12 subcarriers.

### CROSS-REFERENCE TO RELATED APPLICATIONS

This application claims priority to U.S. Provisional Patent Application Ser. No. 61/350,432, filed on Jun. 1, 2010, entitled “METHODS AND SYSTEMS FOR TRANSMISSION OF CSI-RS IN LTE-ADVANCE SYSTEM,” the content of which is incorporated by reference herein in its entirety.

This application is related to previous provisional U.S. Application Ser. No. 61/305,512, entitled “METHODS AND SYSTEMS FOR CSI-RS TRANSMISSION IN LTE-ADVANCE SYSTEMS” and filed Feb. 17, 2010, and another previous provisional U.S. Application Ser. No. 61/307,807, entitled “CSI-RS RESOURCE ALLOCATION IN LTE-ADVANCE SYSTEMS” and filed Feb. 24, 2010, and a third previous provisional U.S. Application Ser. No. 61/349,153, entitled “METHODS AND SYSTEMS FOR TRANSMISSION OF CSI-RS IN LTE-ADVANCE SYSTEMS” and filed May 27, 2010, the contents of all of which are incorporated herein in their entirety.

### FIELD OF THE INVENTION

The present invention relates generally to wireless communication, and more particularly to methods and systems for allocating channel state information reference signals (CSI-RS) resources and transmitting CSI-RS(s) in a wireless communication system.

### BACKGROUND

In wireless communication systems, downlink reference signals are normally created to provide reference for channel estimation used in coherent demodulation as well as a reference for a channel quality measurement used in multi-user scheduling. In the LTE Rel-8 specification, one single type of downlink reference format called a cell-specific reference signal (CRS) is defined for both channel estimation and channel quality measurement. The characteristics of Rel-8 CRS include that, regardless of multiple in, multiple out (MIMO) channel rank that the user equipment (UE) actually needs, the base station can always broadcast the CRS to all UE based on the largest number of MIMO layers/ports.

In the 3GPP LTE Rel-8 system, the transmission time is partitioned into units of a frame that is 10 ms long and is further equally divided into 10 subframes, which are labeled as subframe #0 to subframe #9. While the LTE frequency division duplexing (FDD) system has 10 contiguous downlink subframes and 10 contiguous uplink subframes in each frame, the LTE time-division duplexing (TDD) system has multiple downlink-uplink allocations, whose downlink and uplink subframe assignments are given in Table 1, where the letters D, U and S represent the corresponding subframes and refer respectively to the downlink subframe, uplink subframe and special subframe that contains the downlink transmission in the first part of a subframe and the uplink transmission in the last part of subframe.

TABLE 1
TDD allocation configurations

| Uplink-downlink | Downlink-to-Uplink | | Subframe number | | | | | | | | | |
|---|---|---|---|---|---|---|---|---|---|---|---|---|
| configuration | Switch-point periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In one system configuration instance (called normal cyclic prefix, or normal-CP) in LTE, each subframe includes 2N_{symb}^{DL} 14 equal-duration time symbols with the index from 0 to 13. In another system configuration instance (called extended cyclic prefix, or extended-CP) in LTE, each subframe contains 2N_{symb}^{DL}=12 equal-duration time symbols with the index from 0 to 11. For both CP types, one subframe can be also divided into two equal-duration slots, each of which contains N_{symb}^{DL} time symbols. The frequency domain resource, up to the full bandwidth within one time symbol, is partitioned into subcarriers. One physical resource block (PRB) is defined over a rectangular 2-D frequency-time resource area, covering 12 contiguous subcarriers over the frequency domain and 1 subframe over the time domain, and holding 12*14=168 resource elements (RE), as shown in FIGS. 2(a)-2(b), for example, or 12*12=144 REs for extended-CP subframe as shown in FIGS. 3(a)-3(b). Each regular subframe is partitioned into two parts: the PDCCH (physical downlink control channel) region and PDSCH (physical downlink shared channel) region. The PDCCH region normally occupies the first several symbols per subframe and carries the handset specific control channels, and PDSCH region occupies the rest part of the subframe and carries the general-purpose traffic.

The LTE system requires a Cell-specific Reference Signal (CRS) to be a mandatory downlink signal. CRS serves for downlink signal strength measurement, and for coherent demodulation of PDSCH in the same resource block. CRS transmission for up to four antenna ports has the same pattern in each regular subframe, and occurs on symbols {0,1,4,7,8,11} in normal-CP subframe and symbols {0,1,3,6,7,9} in extended-CP subframe. Each CRS symbol carries 2 CRS REs per port per resource block on frequency domain, as shown in both FIGS. 2(a)-2(b). Error! Reference source not found. and FIGS. 3(a)-3(b). The actual subcarrier index of CRS is shifted by ν_{shift}=N_{ID}^{cell} mod 6, where N_{ID}^{cell} is the cell identification. Besides CRS, LTE Rel-8 also defines a type of UE-specific reference signal (URS) on the antenna port 5. There are 12 URS REs per PRB, occupying 4 symbols in normal-CP subframe as shown in FIG. 2(a) and 3 symbols in extended-CP subframe as shown in FIGS. 3(a)-3(b). The actual subcarrier index of URS is shifted by ν_{shift}=N_{ID}^{cell} mod 3. Though CRS is allocated across the full bandwidth, URS is assigned per PRB basis. FIG. 2(a) and FIGS. 3(a)-3(b) show examples of CRS and URS with ν_{shift}=0.

As 3GPP LTE evolves from Rel-8 to Rel-10 (also called LTE-advance or LTE-A), due to the large number of supported antenna ports (up to 8), it costs too much overhead to maintain the CRS-like reference signal on all ports. It is agreed to separate downlink reference signal roles to different RS signaling:

Demodulation reference signal (DMRS): this type of RS is used for coherent channel estimation and should have sufficient density and should be sent on per UE basis; and

Channel state information reference signal (CSI-RS): this type of RS is used for channel quality measurement by all UE and could be spare over frequency-time domain.

At the time of filing this application, it is agreed in the 3GPP standard body that:

DMRS can be assigned per PRB basis, and DMRS pattern in each PRB is determined to locate at 24 fixed REs in normal-CP subframe as shown in FIG. 2(b) or 32 fixed RE's in extended-CP subframe as shown in FIGS. 3(a)-3(b). There may be two options for DMRS allocation in extended-CP subframe as shown in FIGS. 3(a)-3(b):

CSI-RS RE cannot be allocated to symbols carrying PDCCH and Rel8 CRS, i.e., CSI-RS cannot be allocated to blue REs in FIG. 1;

Denote N_{ANT} as number of CSI-RS antenna ports per cell. The average density of CSI-RS is 1 RE per antenna port per PRB for N_{ANT}ε{2,4,8};

CSI-RS REs per each PRB do not overlap with Rel-10 DMRS RE as well as the Rel-8 URS RE from the same cell; and

CDM-based CSI-RS signal is adopted, which means every two CSI-RS REs are adjacent to each other and construct a CDM pair in either time-domain (referred as CDM-T) or frequency domain (referred as CDM-F).

However, how to allow the CSI-RS and port-5 URS in the extended-CP subframe has not been addressed. Further, there may be additional rules on CSI-RS RE number ordering that are provided in the present application.

This disclosure provides further principles and methods to allocate CSI-RS signals, among other features that will become apparent in light of the following description. These and other implementations and examples of the cell identification methods in software and hardware are described in greater detail in the attached drawings and detailed description.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One embodiment of the present invention is directed to a method of allocating resource elements in an orthogonal frequency division multiplexed (OFDM) system for transmission of a channel state information reference signal (CSI-RS) without overlapping with resource elements allocated to a port-5 user equipment-specific reference signal (URS) signal is disclosed. The method can include shifting in a frequency domain at least a portion of resource elements allocated to the CSI-RS in a normal-CP subframe. According to certain embodiments, the allocation of resource elements can be defined per an 8-port CSI-RS, or per a group of eight CSI-RS resource elements, within a single physical resource block (PRB) whose time-domain dimension is one subframe and whose frequency-domain dimension is 12 subcarriers.

Another embodiment is directed to a system for allocating resource elements in an OFDM system for transmission of a CSI-RS without overlapping with resource elements allocated to a port-5 URS signal. The system can include a shifting unit configured to shift in a frequency domain at least a portion of resource elements allocated to the CSI-RS in a normal-CP subframe; and a patterning unit configured to pattern resource elements in an extended-CP subframe in such a way that there is at least one CSI-RS reuse pattern with no resource element overlapping with the port-5 URS in the extended-CP subframe.

Yet another embodiment is directed to a non-transitory computer-readable medium storing instructions thereof for executing a method of allocating resource elements in an OFDM system for transmission of a CSI-RS without overlapping with resource elements allocated to a port-5 URS signal is disclosed. The method can include shifting in a frequency domain at least a portion of resource elements allocated to the CSI-RS in a normal-CP subframe. According to certain embodiments, the allocation of resource elements can be defined per an 8-port CSI-RS, or per a group of eight CSI-RS resource elements, within a single PRB whose time-domain dimension is one subframe and whose frequency-domain dimension is 12 subcarriers.

According to certain embodiments, the allocation of resource elements can be defined per an 8-port CSI-RS, or per a group of eight CSI-RS resource elements, within a single PRB whose time-domain dimension is one subframe and whose frequency-domain dimension is 12 subcarriers.

Further features and advantages of the present invention, as well as the structure and operation of various embodiments of the present invention, are described in detail below with reference to the accompanying drawings.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily drawn to scale.

FIG. 1 shows an exemplary wireless communication system for transmitting and receiving transmissions, in accordance with one embodiment of the present invention.

FIG. 2(a) shows a physical resource block (PRB) in a normal-CP subframe, which may include a CRS and Rel-8 URS, in accordance with one embodiment of the invention.

FIG. 2(b) shows a PRB in a normal-CP subframe, which may include a CRS and Rel-10 DMRS, in accordance with one embodiment of the invention.

FIG. 3(a) shows a PRB in an extended-CP subframe, which may include a CRS and a Rel-8 URS and a Rel-10 DMRS, for option-1, in accordance with one embodiment of the invention.

FIG. 3(b) shows a PRB in an extended-CP subframe, which may include a CRS and a Rel-8 URS and a Rel-10 DMRS, for option-2, in accordance with one embodiment of the invention.

FIG. 4(a) shows an 8-port CSI-RS multiplexing pattern when F_{CSIRS}=1, with ν_{shift}=0 and a reuse factor of 4, in accordance with one embodiment of the invention.

FIG. 4(b) shows an 8-port CSI-RS multiplexing pattern when F_{CSIRS}=1, with ν_{shift}=1 and a reuse factor of 4, in accordance with one embodiment of the invention.

FIG. 4(d) shows an 8-port CSI-RS multiplexing pattern when F_{CSIRS}=1, with ν_{shift}=2 and a reuse factor of 4, in accordance with one embodiment of the invention.

FIG. 5(a) shows an 8-port CSI-RS multiplexing pattern when F_{CSIRS}=1, with ν_{shift}=0 and a reuse factor of 3, in accordance with one embodiment of the invention.

FIG. 5(b) shows an 8-port CSI-RS multiplexing pattern when F_{CSIRS}=1, with ν_{shift}=1 and a reuse factor of 3, in accordance with one embodiment of the invention.

FIG. 5(d) shows an 8-port CSI-RS multiplexing pattern when F_{CSIRS}=1, with ν_{shift}=2 and a reuse factor of 3, in accordance with one embodiment of the invention.

FIG. 6 shows an 8-port CSI-RS multiplexing pattern when F_{CSIRS}=0 and a reuse factor of 5, in accordance with one embodiment of the invention.

FIG. 7 shows an 8-port CSI-RS multiplexing pattern when F_{CSIRS}=0 and a reuse factor of 6, in accordance with one embodiment of the invention.

FIG. 8(a) shows one type of an 8-port CSI-RS port number time-domain ordering for Aᵣₑᵤₛₑ₌₅^{noURS}, Aᵣₑᵤₛₑ₌₃^{URS} and Aᵣₑᵤₛₑ₌₄^{URS} (0≦r≦1), in accordance with one embodiment of the invention.

FIG. 8(b) shows one type of an 8-port CSI-RS port number frequency-domain ordering for Aᵣₑᵤₛₑ₌₅^{noURS}, Aᵣₑᵤₛₑ₌₃^{URS} and Aᵣₑᵤₛₑ₌₄^{URS} (0≦r≦1), in accordance with one embodiment of the invention.

FIG. 9(a) shows one type of an 8-port CSI-RS port number time-domain ordering for Aᵣₑᵤₛₑ₌₄^{URS} (2≦r≦3), in accordance with one embodiment of the invention.

FIG. 9(b) shows one type of an 8-port CSI-RS port number frequency-domain ordering for Aᵣₑᵤₛₑ₌₄^{URS} (2≦r≦3) in accordance with one embodiment of the invention.

FIG. 10(a) shows a type of an 8-port CSI-RS port number time-domain ordering for Aᵣₑᵤₛₑ₌₅^{noURS}, Aᵣₑᵤₛₑ₌₃^{URS} and Aᵣₑᵤₛₑ₌₄^{URS} (0≦r≦1), in accordance with one embodiment of the invention.

FIG. 10(b) shows a type of an 8-port CST-RS port number frequency-domain ordering for Aᵣₑᵤₛₑ₌₅^{noURS}, Aᵣₑᵤₛₑ₌₃^{URS} and Aᵣₑᵤₛₑ₌₄^{URS} (0≦r≦1), in accordance with one embodiment of the invention.

FIG. 11(a) shows a type of 8-port CSI-RS port number time-domain ordering for Aᵣₑᵤₛₑ₌₄^{URS} (2≦r≦3), in accordance with one embodiment of the invention.

FIG. 11(b) shows a type of 8-port CSI-RS port number frequency-domain ordering for Aᵣₑᵤₛₑ₌₄^{URS} (2≦r≦3), in accordance with one embodiment of the invention.

FIG. 12(a) shows a CSI-RS pattern in an extended-CP subframe (reuse factor=3 and ν_{shift}=0) where the CSI-RS and a port-5 URS do not share one subframe, according to option-1, in accordance with one embodiment of the invention.

FIG. 12(b) shows a CSI-RS pattern in an extended-CP subframe (reuse factor=3 and ν_{shift}=1) where the CSI-RS and a port-5 URS do not share one subframe, according to option-1, in accordance with one embodiment of the invention.

FIG. 12(c) shows a CSI-RS pattern in an extended-CP subframe (reuse factor=3 and ν_{shift}=2) where the CSI-RS and a port-5 URS do not share one subframe, according to option-1, in accordance with one embodiment of the invention.

FIG. 13(a) shows a CSI-RS pattern in an extended-CP subframe (reuse factor=3 and ν_{shift}=0) where the CSI-RS and a port-5 URS do not share one subframe, according to option-2, in accordance with one embodiment of the invention.

FIG. 13(b) shows a CSI-RS pattern in an extended-CP subframe (reuse factor=3 and ν_{shift}=1) where the CSI-RS and a port-5 URS do not share one subframe, according to option-2, in accordance with one embodiment of the invention.

FIG. 13(c) shows a CSI-RS pattern in an extended-CP subframe (reuse factor=3 and ν_{shift}=2) where the CSI-RS and a port-5 URS do not share one subframe, according to option-2, in accordance with one embodiment of the invention.

FIG. 14 shows a CSI-RS pattern in an extended-CP subframe (reuse factor=3) where CSI-RS and port-5 URS share one subframe and Rel-10 DMRS is in an option-2 allocation, in accordance with one embodiment of the invention.

FIG. 15(a) shows CSI-RS RE number time-domain (type-1) ordering in an extended-CP subframe, in accordance with one embodiment of the invention.

FIG. 15(b) shows CSI-RS RE number time-domain (type-2) ordering in an extended-CP subframe, in accordance with one embodiment of the invention.

FIG. 15(c) shows CSI-RS RE number frequency-domain (type-1) ordering in an extended-CP subframe, in accordance with one embodiment of the invention.

FIG. 15(d) shows CSI-RS RE number frequency-domain (type-2) ordering in an extended-CP subframe, in accordance with one embodiment of the invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

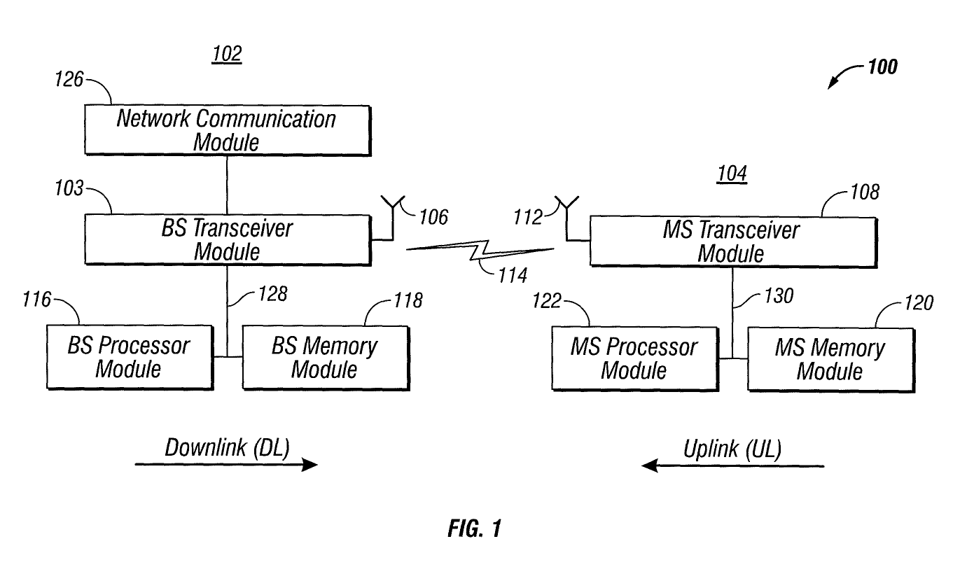

FIG. 1 shows an exemplary wireless communication system 100 for transmitting and receiving transmissions, in accordance with one embodiment of the present invention. The system 100 may include components and elements configured to support known or conventional operating features that need not be described in detail herein. System 100 generally comprises a base station 102 with a base station transceiver module 103, a base station antenna 106, a base station processor module 116 and a base station memory module 118. System 100 generally comprises a mobile station 104 with a mobile station transceiver module 108, a mobile station antenna 112, a mobile station memory module 120, a mobile station processor module 122, and a network communication module 126. Of course both base station 102 and mobile station 104 may include additional or alternative modules without departing from the scope of the present invention. Further, only one base station 102 and one mobile station 104 is shown in the exemplary system 100; however, any number of base stations 102 and mobile stations 104 could be included.

These and other elements of system 100 may be interconnected together using a data communication bus (e.g., 128, 130), or any suitable interconnection arrangement. Such interconnection facilitates communication between the various elements of wireless system 100. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary system 100, the base station transceiver 103 and the mobile station transceiver 108 each comprise a transmitter module and a receiver module (not shown). Additionally, although not shown in this figure, those skilled in the art will recognize that a transmitter may transmit to more than one receiver, and that multiple transmitters may transmit to the same receiver. In a TDD system, transmit and receive timing gaps exist as guard bands to protect against transitions from transmit to receive and vice versa.

In the particular example system depicted in FIG. 1, an “uplink” transceiver 108 includes a transmitter that shares an antenna with an uplink receiver. A duplex switch may alternatively couple the uplink transmitter or receiver to the uplink antenna in time duplex fashion. Similarly, a “downlink” transceiver 103 includes a receiver which shares a downlink antenna with a downlink transmitter. A downlink duplex switch may alternatively couple the downlink transmitter or receiver to the downlink antenna in time duplex fashion.

The mobile station transceiver 108 and the base station transceiver 103 are configured to communicate via a wireless data communication link 114. The mobile station transceiver 108 and the base station transceiver 102 cooperate with a suitably configured RF antenna arrangement 106/112 that can support a particular wireless communication protocol and modulation scheme. In the exemplary embodiment, the mobile station transceiver 108 and the base station transceiver 102 are configured to support industry standards such as the Third Generation Partnership Project Long Term Evolution (3GPP LTE), Third Generation Partnership Project 2 Ultra Mobile Broadband (3 Gpp2 UMB), Time Division-Synchronous Code Division Multiple Access (TD-SCDMA), and Wireless Interoperability for Microwave Access (WiMAX), and the like. The mobile station transceiver 108 and the base station transceiver 102 may be configured to support alternate, or additional, wireless data communication protocols, including future variations of IEEE 802.16, such as 802.16e, 802.16m, and so on.

According to certain embodiments, the base station 102 controls the radio resource allocations and assignments, and the mobile station 104 is configured to decode and interpret the allocation protocol. For example, such embodiments may be employed in systems where multiple mobile stations 104 share the same radio channel which is controlled by one base station 102. However, in alternative embodiments, the mobile station 104 controls allocation of radio resources for a particular link, and could implement the role of radio resource controller or allocator, as described herein.

Processor modules 116/122 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 116/122 comprise processing logic that is configured to carry out the functions, techniques, and processing tasks associated with the operation of system 100. In particular, the processing logic is configured to support the frame structure parameters described herein. In practical embodiments the processing logic may be resident in the base station and/or may be part of a network architecture that communicates with the base station transceiver 103.

The steps of a method or algorithm described in connection with the embodiments disclosed herein may be embodied directly in hardware, in firmware, in a software module executed by processor modules 116/122, or in any practical combination thereof. A software module may reside in memory modules 118/120, which may be realized as RAM memory, flash memory, ROM memory, EPROM memory, EEPROM memory, registers, a hard disk, a removable disk, a CD-ROM, or any other form of storage medium known in the art. In this regard, memory modules 118/120 may be coupled to the processor modules 118/122 respectively such that the processors modules 116/120 can read information from, and write information to, memory modules 118/120. As an example, processor module 116, and memory modules 118, processor module 122, and memory module 120 may reside in their respective ASICs. The memory modules 118/120 may also be integrated into the processor modules 116/120. In an embodiment, the memory module 118/220 may include a cache memory for storing temporary variables or other intermediate information during execution of instructions to be executed by processor modules 116/222. Memory modules 118/120 may also include non-volatile memory for storing instructions to be executed by the processor modules 116/120.

Memory modules 118/120 may include a frame structure database (not shown) in accordance with an exemplary embodiment of the invention. Frame structure parameter databases may be configured to store, maintain, and provide data as needed to support the functionality of system 100 in the manner described below. Moreover, a frame structure database may be a local database coupled to the processors 116/122, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 126 generally represents the hardware, software, firmware, processing logic, and/or other components of system 100 that enable bi-directional communication between base station transceiver 103, and network components to which the base station transceiver 103 is connected. For example, network communication module 126 may be configured to support interne or WiMAX traffic. In a typical deployment, without limitation, network communication module 126 provides an 802.3 Ethernet interface such that base station transceiver 103 can communicate with a conventional Ethernet based computer network. In this manner, the network communication module 126 may include a physical interface for connection to the computer network (e.g., Mobile Switching Center (MSC)).

Note that the functions described in the present disclosure may be performed by either a base station 102 or a mobile station 104. A mobile station 104 may be any user device such as a mobile phone, and a mobile station may also be referred to as UE.

Embodiments disclosed herein have specific application but not limited to the Long Term Evolution (LTE) system that is one of the candidates for the 4-th generation wireless system. Embodiments described herein provide various CSI-RS per-cell patterns. Various of these CSI-RS per-cell patterns show a layout of eight CSI-RS REs that can belong to one single cell, according to certain embodiments.

### CSI-RS Allocation in a Normal-CP Subframe

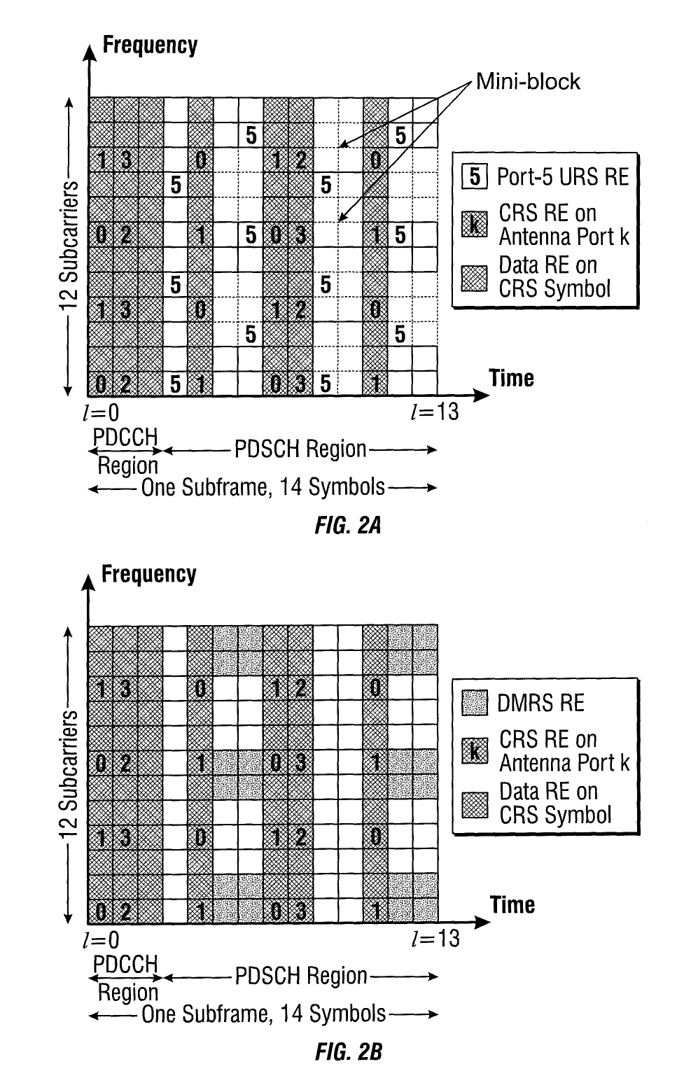

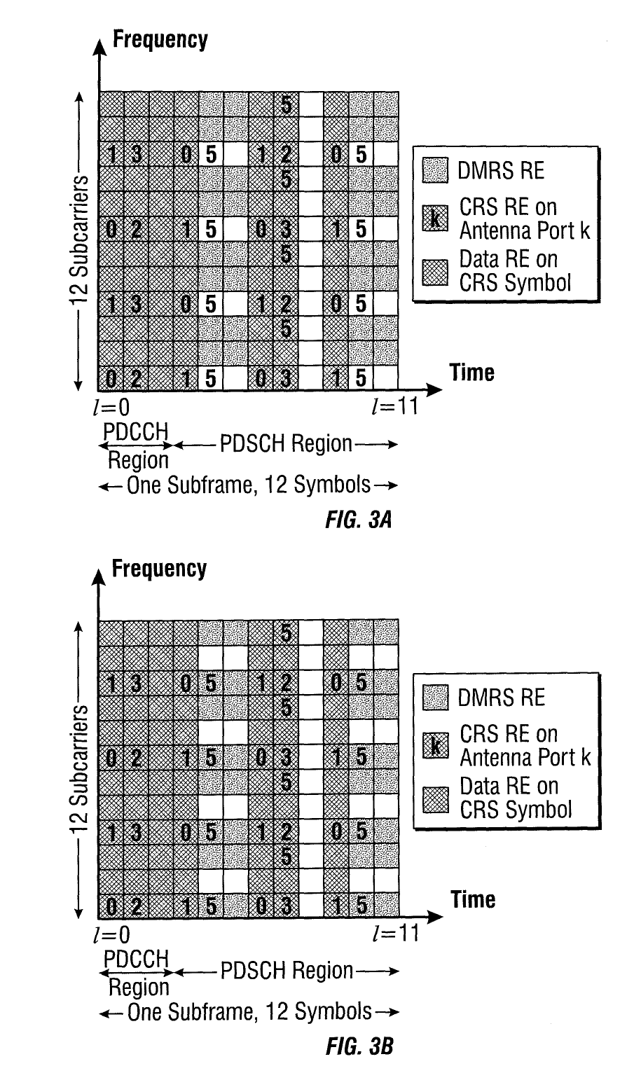

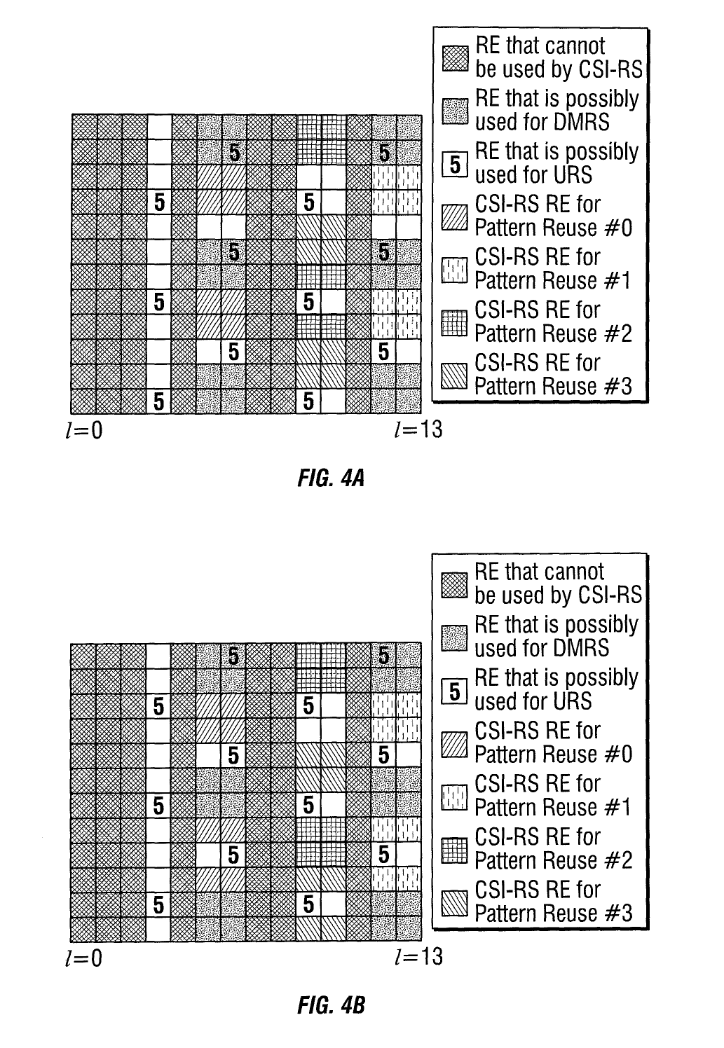

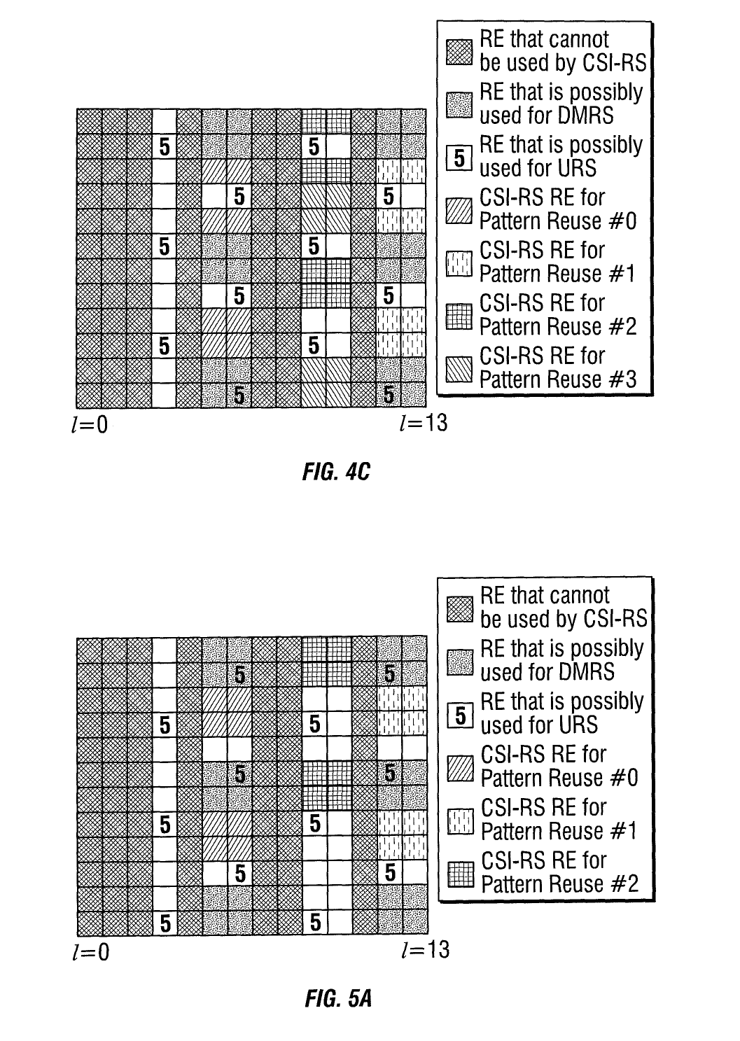

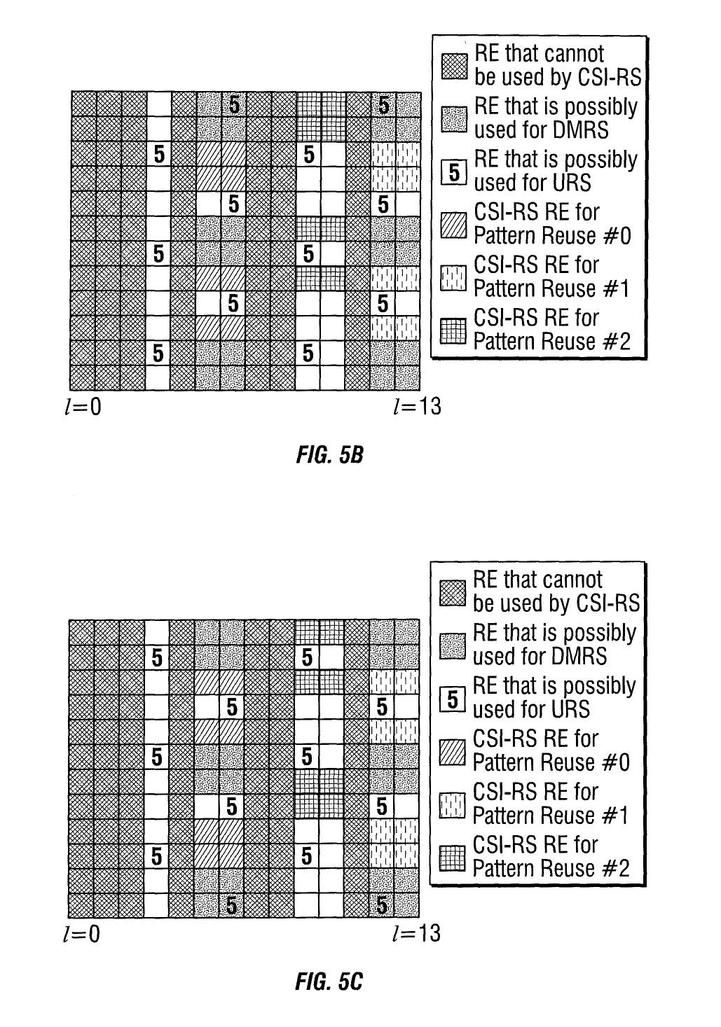

Assume the i-th RE location for cell-r (or the reuse pattern r) is given by <k_{r,i},l_{r,i}> for 0≦i<N_{CSI} (N_{CSI}ε{8,4,2}), where k_{r,i} and l_{r,i} are subcarrier index and symbol index, respectively, both counting from 0 and starting at the lower-left corner of each PRB in FIGS. 2(a) and 2(b) and FIGS. 3(a) and 3(b), for example. An exemplary CSI-RS allocation (denoted as Aᵣₑᵤₛₑ₌₄^{URS}) is depicted with reuse factor equal to 4 and coexisting with port-5 URS, as shown in FIGS. 4(a)-4(c), as well as a CSI-RS allocation (denoted as Aᵣₑᵤₛₑ₌₃^{URS}) with reuse factor equal to 3 and coexisting with port-5 URS, as shown FIGS. 5(a)-5(c).

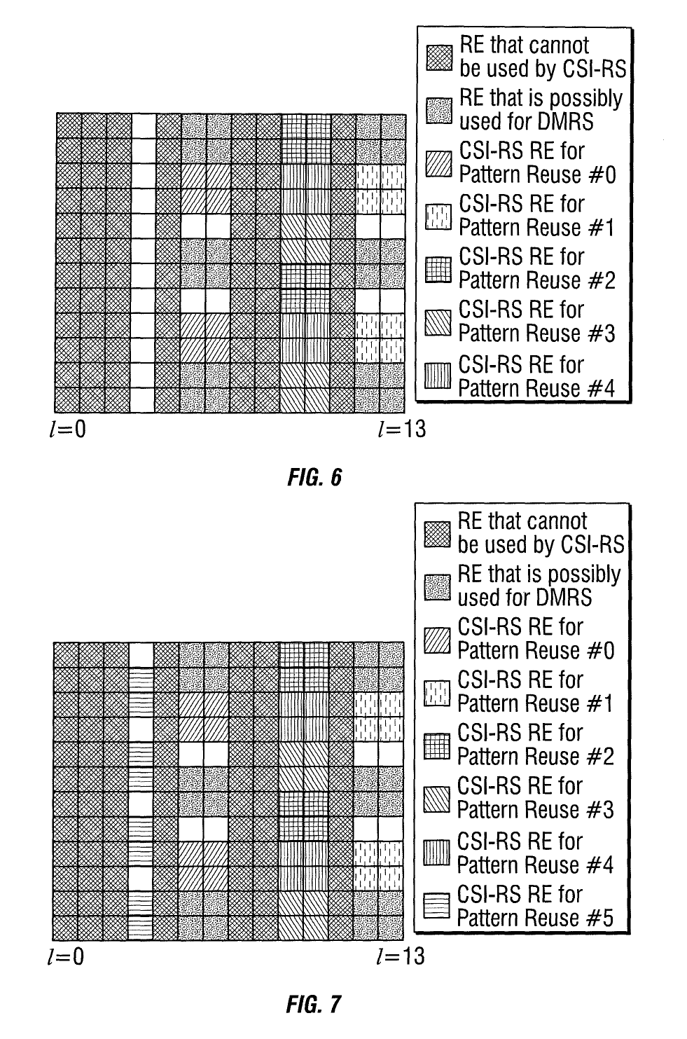

In addition, an exemplary CSI-RS allocation (denoted as Aᵣₑᵤₛₑ₌₅^{noURS}) is depicted with a reuse factor equal to 5 and not coexisting with port-5 URS, as shown in FIG. 6, as well as a CSI-RS allocation (denoted as Aᵣₑᵤₛₑ₌₆^{noURS}) with a reuse factor equal to 6 and not coexisting with port-5 URS, as shown in FIG. 7.

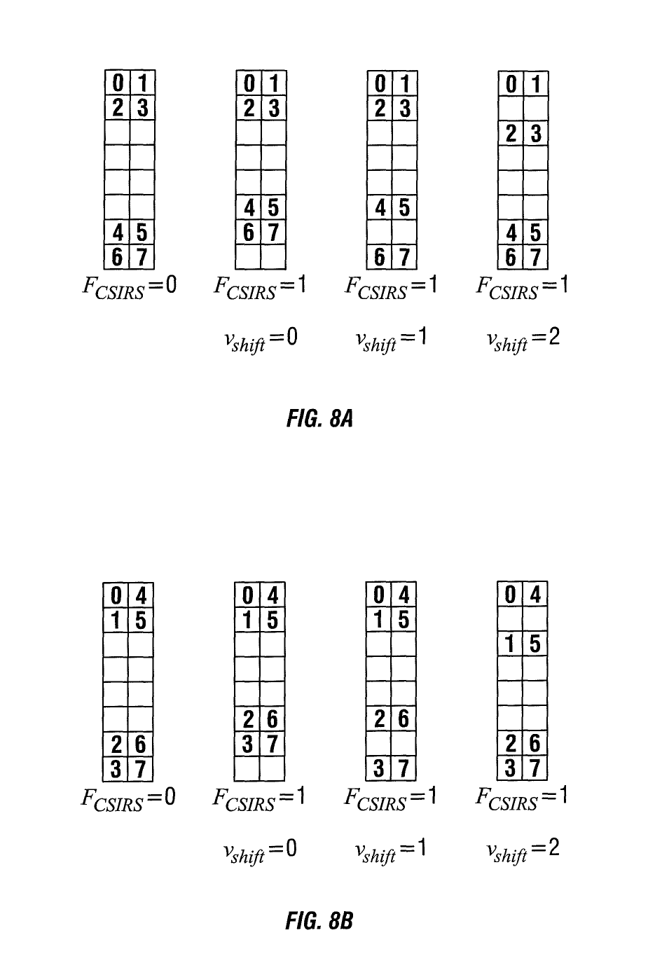

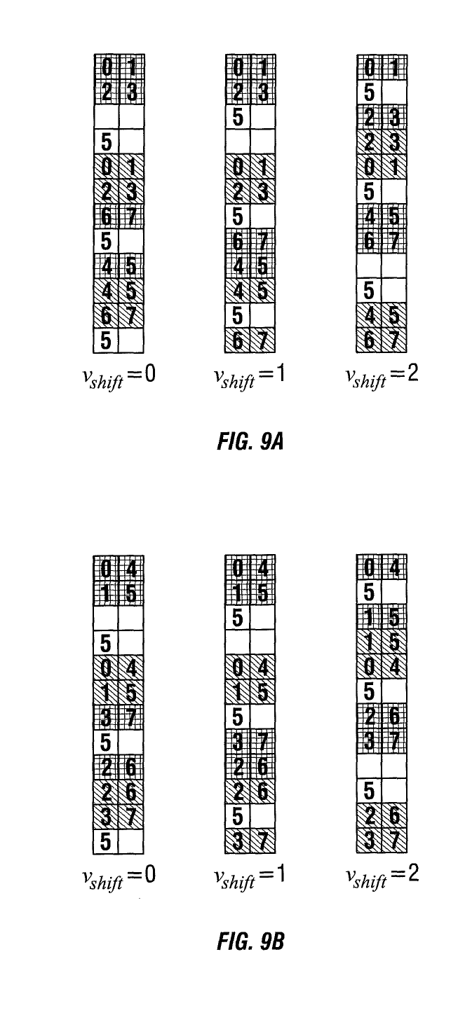

The resource location inside a PRB for CSI-RS RE #0, <k_{r,0},l_{r,0}>, can be defined in Table 2 for a normal-CP subframe. The RE location numbering inside the PRB for other CSI-RS REs, <k_{r,i},l_{r,i}>, are depicted in FIGS. 8(a)-8(b) and FIGS. 9(a)-9(b).

TABLE 2
Resource allocation of CSI-RS RE #0 in a normal-CP subframe

| | | applicable | | | |
|---|---|---|---|---|---|
| Reuse pattern index, r | <k_{r,0}, l_{r,0}> | Aᵣₑᵤₛₑ₌₃^{URS} | Aᵣₑᵤₛₑ₌₄^{URS} | Aᵣₑᵤₛₑ₌₅^{noURS} | Aᵣₑᵤₛₑ₌₆^{noURS} |
| 0 | <9, 5> | ✓ | ✓ | ✓ | ✓ |
| 1 | <9, 12> | ✓ | ✓ | ✓ | ✓ |
| 2 | <11, 9> | ✓ | ✓ | ✓ | ✓ |
| 3 | <7, 9> | | ✓ | ✓ | ✓ |
| 4 | <9, 9> | | | ✓ | ✓ |
| 5 | <*, 3> | | | | ✓ |

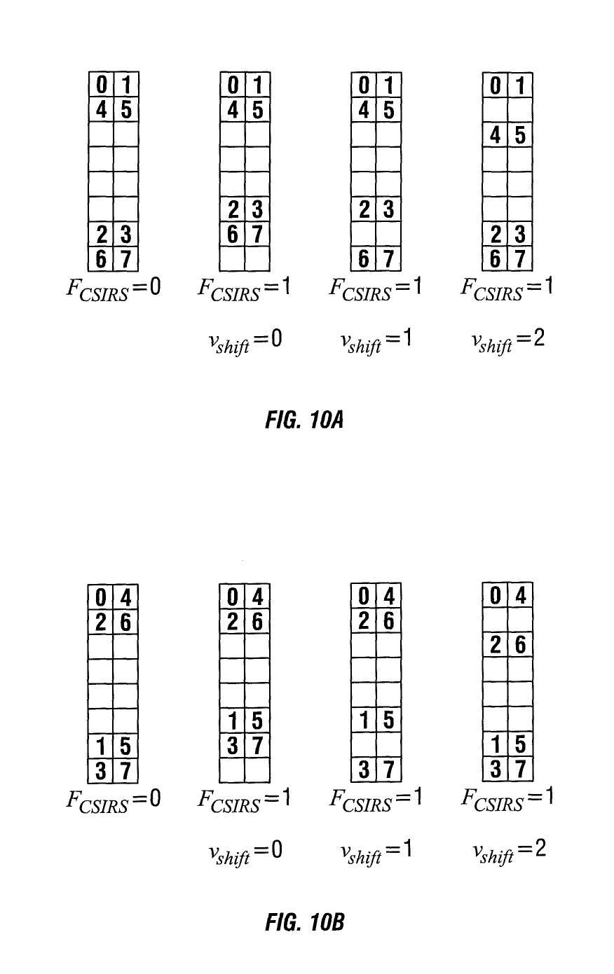

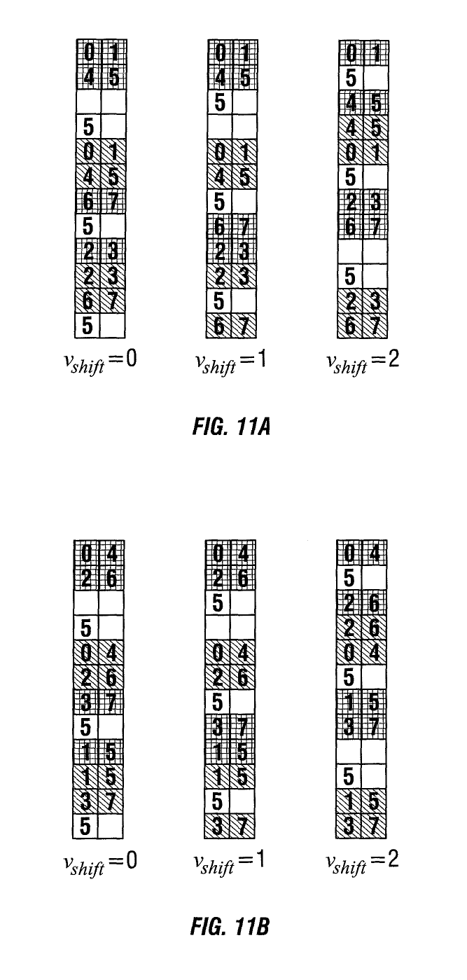

Besides the exemplary RE location numbering as shown in FIGS. 8(a)-8(b) and FIGS. 9(a)-9(b), this disclosure further defines an exemplary RE location numbering as shown in FIGS. 10(a)-10(b) and FIGS. 11(a)-11(b), whose mathematic formula is defined by:

For time-domain ordering first:

$$\begin{matrix}{l}_{r , i} = {l}_{r , 0} + ( i mod 2 ) for 0 < i < 8 and & ( 1 ) \\ {k}_{r , 2 j + 1} = {k}_{r , 2 j} = {k}_{r , 0} - ( j mod 2 ) \times 6 - ⌊ \frac{j}{2} ⌋ + {Δ}_{j} for 0 \leq j < 4 & ( 2 )\end{matrix}$$

For frequency-domain ordering first:

$$\begin{matrix}{l}_{r , i} = {l}_{r , 0} + ⌊ \frac{i}{4} ⌋ for 0 < i < 8 and & ( 3 ) \\ {k}_{r , j + 4} = {k}_{r , j} = {k}_{r , 0} - ( j mod 2 ) \times 6 - ⌊ \frac{j}{2} ⌋ + {Δ}_{j} for 0 \leq j < 4 & ( 4 )\end{matrix}$$

The definition of Δⱼ is given below:

$$\begin{matrix}For 0 \leq r \leq 4 in {A}_{reuse = 5}^{noURS} and {A}_{reuse = 6}^{noURS} ( i . e . , {F}_{CSIRS} = 0 ) , \\ {Δ}_{j} = 0 \\ For 0 \leq r \leq 2 in {A}_{reuse = 3}^{URS} and 0 \leq r \leq 1 in {A}_{reuse = 4}^{URS} , \\ {Δ}_{j} = {δ}_{j} , where & ( 5 ) \\ {δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise\end{matrix} & ( 6 ) \\ For 2 \leq r \leq 3 in {A}_{reuse = 4}^{URS} , \\ {Δ}_{j} = ⌊ \frac{j}{2} ⌋ - ( {k}_{r , 0} mod 3 ) + ( [ {k}_{r , 0} - ⌊ \frac{j}{2} ⌋ + {δ}_{j} ] mod 3 ) & ( 7 )\end{matrix}$$

where δⱼ is defined above in Eq. (6). It is can be seen that, the avoidance of resource element overlapping between a CSI-RS and a port-5 URS in a normal-CP subframe can be realized by introducing the frequency domain RE shifting parameter Δⱼ.

Regardless of how the CSI-RS RE number ordering is performed, the 4-port CSI-RS allocation can use the CSI-RS REs {0,1,2,3} or {4,5,6,7} in 8-port CSI-RS allocation, and the choice between {0,1,2,3} and {4,5,6,7} can be either signaled by high-layer signaling or automatically determined by ƒ(N_{ID}^{cell})mod 2, for example. The 2-port CSI-RS allocation can use the CSI-RS REs labeled by {2j,2j+1} defined in 8-port CSI-RS allocation, and the choice among four such pairs can be either signaled by high-layer signaling or automatically determined by ƒ(N_{ID}^{cell})mod 4. It is noted that ƒ(N_{ID}^{cell}) is a certain exemplary function of cell identification where, for example, ƒ(N_{ID}^{cell})=N_{ID}^{cell} or

$$f ( {N}_{ID}^{cell} ) = ⌊ \frac{{N}_{ID}^{cell}}{R} ⌋ ,$$

R being the reuse factor per subframe according to this embodiment.

One of ordinary skill in the art would realize that partial muting can still apply to the exemplary port numberings defined herein. That is, muting can be applied to the REs overlapping with CSI-RS from neighboring cells, and meanwhile falling into symbols {5,10,13}, for example. The REs on the symbols {6,9,12} may not be muted, even though those REs may overlap with CSI-RS REs from neighboring cells, according to certain embodiment.

### CSI-RS Allocation in an Extended-CP Subframe

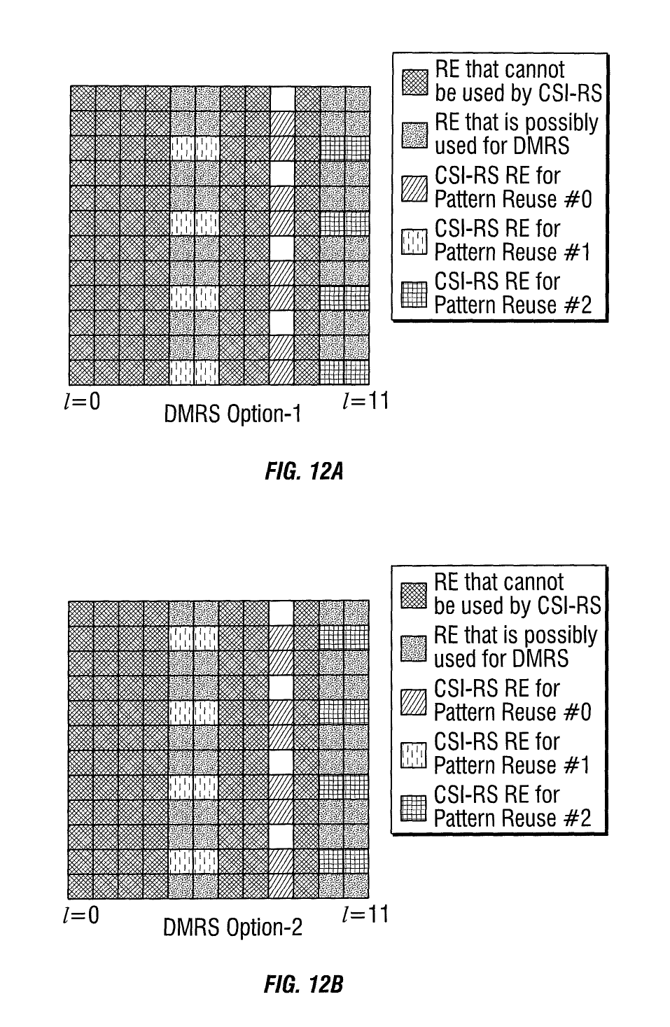

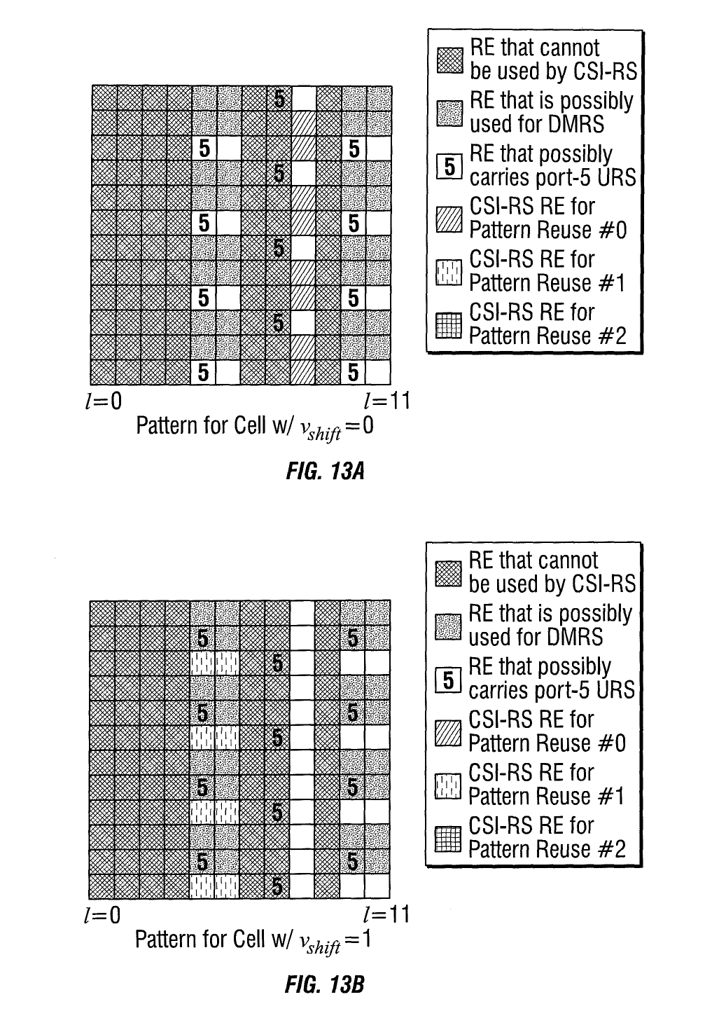

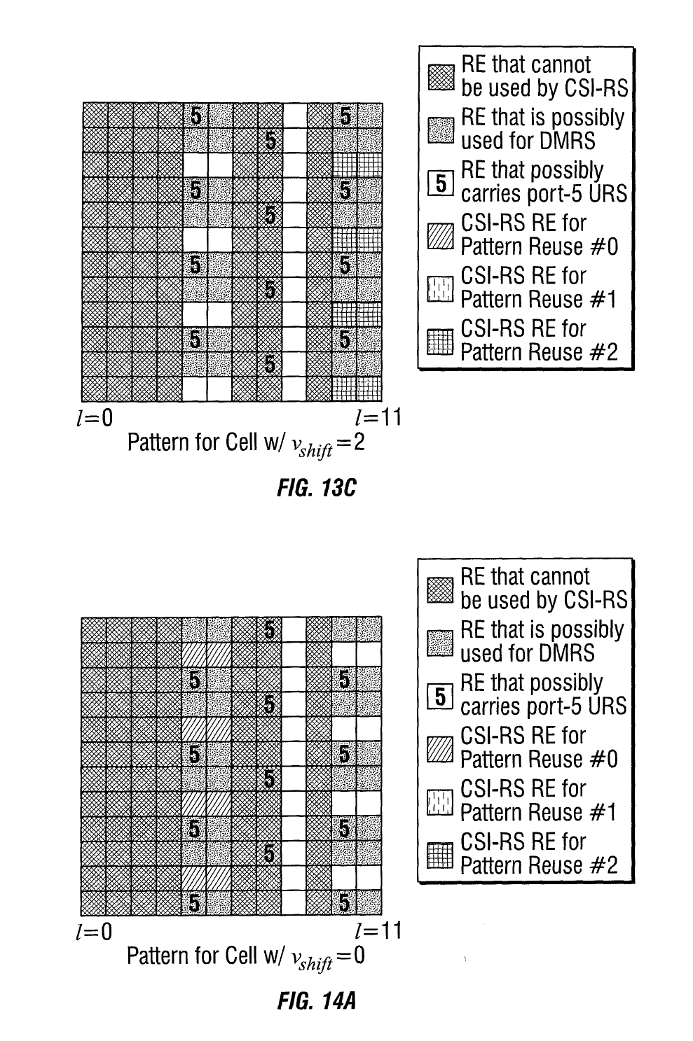

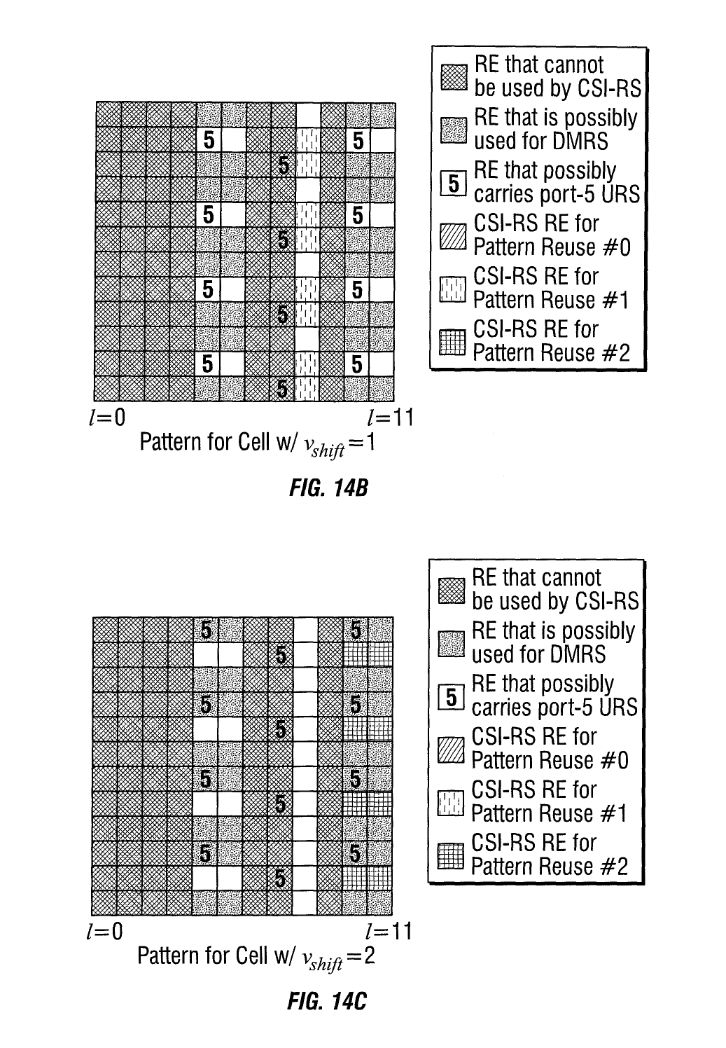

When CSI-RS and port-5 URS are not transmitted in the same extended-CP subframe, for example, 8-port CSI-RS REs can be allocated as shown in FIGS. 12(a) and 12(b) to reach a reuse factor per subframe equal to 3. According to the present embodiment, one CDM-T based reuse pattern can be located on non-DMRS REs in symbol pair {4,5}, a second CDM-T based reuse pattern can be located on non-DMRS REs in symbol pair {10,11}, and the third reuse pattern, which can be CDM-F based pattern, can be located on symbol {8}. When CSI-RS and port-5 URS can be transmitted in the same extended-CP subframe, 8-port CSI-RS REs can be allocated as shown in FIGS. 13(a)-13(c) as option-1 DMRS allocation and as shown in FIGS. 14(a)-14(c) as option-2 DMRS allocation, both with a reuse factor equal to 3, according to this example.

For either DMRS allocation exemplary option-1 or option-2, the cell whose ν_{shift} value makes the port-5 URS falling on non-DMRS REs within symbol pairs {4,5} and {10,11} can have its CSI-RS allocated to symbol {8}, for example, with CDM-F multiplexing. Such examples may be illustrated by a cell with ν_{shift}=0 in type-1 DMRS allocation, as shown in FIGS. 13(a)-13(c) and a cell with ν_{shift}=1 in type-2 DMRS allocation in FIGS. 14(a)-14(c). In other words, the CSI-RS in the extended-CP subframe can be designed in such a way that there is at least one CSI-RS reuse pattern with no resource element overlapping with port-5 URS.

Similar to the CSI-RS reuse pattern in a normal-CP subframe, each CSI-RS reuse pattern in an extended-CP subframe can be identified by the frequency-time location of CSI-RS RE #0, <k_{r,0},l_{r,0}>, which is defined in Table 3 below. The locations of other CSI-RS REs, <k_{r,i},l_{r,i}>, can be derived from <k_{r,0},l_{r,0}>. l_{r,0} in Table 3 counts from 0 to 11 and serves as the symbol index per extended-CP subframe. In some circumstances, the symbol index is also defined per slot-basis. In such cases, each CSI-RS reuse pattern under the extended-CP subframe can be identified by the frequency-time location of CSI-RS RE #0 per slot as well as the slot index per subframe, <k_{r,0},l_{r,0}, nₛ>, which is defined in Table 4 below.

TABLE 3
Resource allocation of CSI-RS RE #0 in an extended-CP subframe

| | <k_{r,0}, l_{r,0}> | |
|---|---|---|
| | DMRS | |
| Reuse pattern index, r | allocation option-1 | DMRS allocation option-2 |
| 0 | <*, 8> | <10, 4> |
| 1 | <9, 4> | <*, 8> |
| 2 | <9, 10> | <10, 10> |

TABLE 4
Resource allocation of CSI-RS RE #0 in an extended-CP subframe

| | <k_{r,0}, l_{r,0}, nₛ> | |
|---|---|---|
| | DMRS | |
| Reuse pattern index, r | allocation option-1 | DMRS allocation option-2 |
| 0 | <*, 2, 1> | <10, 4, 0> |
| 1 | <9, 4, 0> | <*, 2, 1> |
| 2 | <9, 4, 1> | <10, 4, 1> |

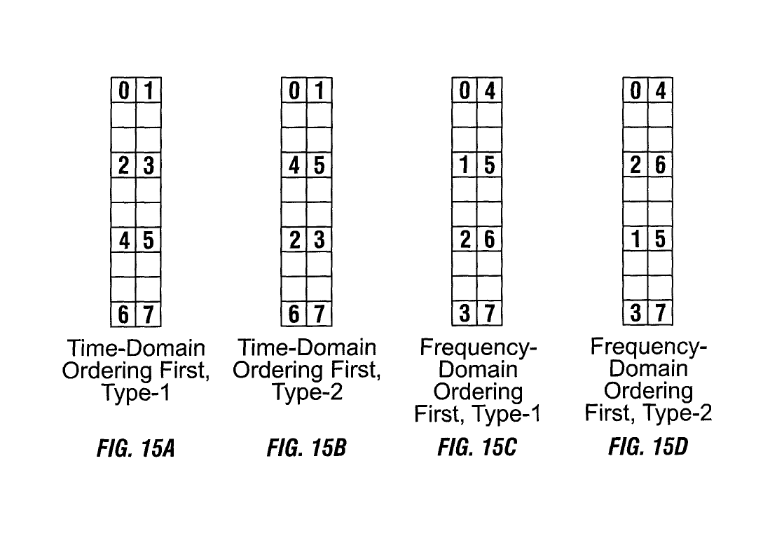

There may be two exemplary types of CSI-RS RE number ordering for a CDM-T based reuse pattern, and each type can include both time-domain ordering first and frequency-domain ordering first, as shown in FIGS. 15(a)-15(d).

1) Type-1 (see FIGS. 15(a) and 15(c)) CSI-RS RE number ordering
For time-domain ordering first:

l_{r,i}=l_{r,0}+(i mod 2)for 0<i<8 and (8)

k_{r,2j+1}=k_{r,2j}=k_{r,0}−3×j for 0<j<4(in order to define k_{r,1}) (9)
For frequency-domain ordering first:

$$\begin{matrix}{l}_{r , i} = {l}_{r , 0} + ⌊ \frac{i}{4} ⌋ for 0 < i < 8 and & ( 10 ) \\ {k}_{r , j + 4} = {k}_{r , j} = {k}_{r , 0} - 3 \times j for 0 \leq j < 4 & ( 11 )\end{matrix}$$

2) Type-2 (see FIGS. 15(b) and 15(d)) CSI-RS RE number ordering
For time-domain ordering first:

$$\begin{matrix}{l}_{r , i} = {l}_{r , 0} + ( i mod 2 ) for 0 < i < 8 and & ( 12 ) \\ {k}_{r , 2 j + 1} = {k}_{r , 2 j} = {k}_{r , 0} - ( j mod 2 ) \times 6 - ⌊ \frac{j}{2} ⌋ \times 3 for 0 \leq j < 4 & ( 13 )\end{matrix}$$

For frequency-domain ordering first:

$$\begin{matrix}{l}_{r , i} = {l}_{r , 0} + ⌊ \frac{i}{4} ⌋ for 0 < i < 8 and & ( 14 ) \\ {k}_{r , j + 4} = {k}_{r , j} = {k}_{r , 0} - ( j mod 2 ) \times 6 - ⌊ \frac{j}{2} ⌋ \times 3 for 0 \leq j < 4 & ( 15 )\end{matrix}$$

For any exemplary CSI-RS RE number ordering in an extended-CP subframe, the 4-port CSI-RS allocation can use the CSI-RS REs {0,1,2,3} or {4,5,6,7} in 8-port CSI-RS allocation, and the choice between {0,1,2,3} and {4,5,6,7} can be either signaled by high-layer signaling or automatically determined by ƒ(N_{ID}^{cell})mod 2. The 2-port CSI-RS allocation can use the CSI-RS REs labeled by {2j,2j+1} defined in 8-port CSI-RS allocation, and the choice among four such pairs can be either signaled by high-layer signaling or automatically determined by ƒ(N_{ID}^{cell})mod 4. It is noted that ƒ(N_{ID}^{cell}) can be a certain function of cell identification such as, for example, ƒ(N_{ID}^{cell})=N_{ID}^{cell} or

$$f ( {N}_{ID}^{cell} ) = ⌊ \frac{{N}_{ID}^{cell}}{R} ⌋ ,$$

R being the reuse factor per subframe, according to an exemplary embodiment.

The partial muting rule in a normal-CP subframe including the port-5 URS is can also be valid in an extended-CP subframe containing the port-5 URS. The PDSCH muting can be applied to the REs overlapping with a CSI-RS from a neighboring cell and meanwhile falling into symbols {5,8,11}, for example. The REs on the symbols {4,10} may not be muted, even though those REs may overlap with CSI-RS REs from neighboring cells, according to various embodiments.

In a communication system of 3GPP LTE and/or LTE-A, the CSI-RS transmission method and related signaling flow and process may be implemented in form of software instructions or firmware instructions for execution by a processor in the transmitter and receiver or the transmission and reception controller. In operation, the instructions are executed by one or more processors to cause the transmitter and receiver or the transmission and reception controller to perform the described functions and operations.

While various embodiments of the invention have been described above, it should be understood that they have been presented by way of example only, and not by way of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the invention, whether or not such embodiments are described, and whether or not such features are presented as being a part of a described embodiment. Thus the breadth and scope of the present invention should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of allocating resource elements in an orthogonal frequency division multiplexed (OFDM) system for transmission of a channel state information reference signal (CSI-RS) without overlapping with resource elements allocated to a port-5 user equipment-specific reference signal (URS) signal, comprising:
shifting in a frequency domain at least a portion of resource elements allocated to the CSI-RS in a normal-CP subframe; and
patterning resource elements in an extended-CP subframe in such a way that there is at least one CSI-RS reuse pattern with no resource element overlapping with the port-5 URS in the extended-CP subframe.

2. The method of claim 1, wherein the allocation of resource elements is defined per an 8-port CSI-RS, or per a group of eight CSI-RS resource elements, within a single physical resource block (PRB) whose time-domain dimension is one subframe and whose frequency-domain dimension is 12 subcarriers.

3. The method of claim 1, wherein for the normal-CP subframe, the CSI-RS resource element index ordering in each pattern is provided by at least one of time domain ordering and frequency domain ordering, and the location within the PRB of the i-th CSI-RS resource element, represented by (kᵢ,lᵢ), is given by lᵢ=l′+(i mod 2) for 0≦i<8 and
$${k}_{2 j} = {k}_{2 j + 1} = {k}^{′} - ( j mod 2 ) \times 6 - ⌊ \frac{j}{2} ⌋ + {Δ}_{j} for 0 \leq j < 4 ,$$
where (k′,l′) is the location of a CSI-RS resource element with a largest subcarrier index and smallest symbol index in each CSI-RS per-cell pattern, and Δⱼ is used to perform resource element shifting in frequency domain.

4. The method of claim 3, wherein Δⱼ can be one of following:
$${Δ}_{j} = 0 ;$$
$${Δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise ;\end{matrix} \\ or \\ {Δ}_{j} = \{ \begin{matrix}{δ}_{j} & 0 \leq r \leq 1 \\ ⌊ \frac{j}{2} ⌋ - ( {k}^{′} mod 3 ) + ( [ {k}^{′} - ⌊ \frac{j}{2} ⌋ + {δ}_{j} ] mod 3 ) & 2 \leq r \leq 3 ,\end{matrix} \\ where \\ {δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise\end{matrix}$$

5. The method of claim 1, wherein for the extended-CP subframe, the CSI-RS resource elements per cell are patterned within the PRB as pairs of CSI-RS resource elements located within the same two ODFM symbols at every third pair of subcarriers counting downward from a pair of CSI-RS resource elements with a largest subcarrier index on the two OFDM symbols in one PRB.

6. The method of claim 5, wherein the same two OFDM symbols where pairs of CSI-RS resource elements are allocated are symbol 4 and symbol 5 in either slot of one subframe.

7. The method of claim 5, wherein the largest subcarrier index of the pair of CSI-RS resource elements in one PRB is a value from {9,10}.

8. The method of claim 5, wherein the CSI-RS resource element index ordering in each pattern is provided by at least one of time domain ordering and frequency domain ordering, and the location within the PRB of the i-th CSI-RS RE, represented by (kᵢ,lᵢ), is given by lᵢ=l′+(i mod 2) for 0≦i<8 and k₂ⱼ=k₂ⱼ₊₁=k′−3×j for 0≦j<4, where (k′,l′) is the location of a CSI-RS resource element with a largest subcarrier index and smallest symbol index in each CSI-RS per-cell pattern.

9. The method of claim 2, wherein
any four CSI-RS resource elements with indices 0˜3 or 4˜7 in an 8-port CSI-RS resource element allocation are used for a 4-port CSI-RS allocation, and the choice between 0˜3 and 4˜7 is at least one of signaled by high-layer signaling and automatically determined by ƒ(N_{ID}^{cell})mod 2,
any two CSI-RS resource elements with indices (2j) and (2j+1) in an 8-port CSI-RS resource element allocation are used for a 2-port CSI-RS allocation, and the choice among four such pairs is at least one of signaled by high-layer signaling and automatically determined by ƒ(N_{ID}^{cell})mod 4, and
ƒ(N_{ID}^{cell}) is a function of cell identification, where ƒ(N_{ID}^{cell})=N_{ID}^{cell} or
$$f ( {N}_{ID}^{cell} ) = ⌊ \frac{{N}_{ID}^{cell}}{R} ⌋ ,$$
R being a reuse factor per subframe.

10. The method of claim 1, wherein for all resource elements overlapping one or more CSI-RS resource elements from neighboring cells:
overlapping resource elements on the symbols that are not available to carry a port-5 URS are muted, where the muting is performed on resource elements falling into symbols {5,8,11} per subframe, and
the resource elements on symbols that are available to carry a port-5 URS are not muted, even though the resource elements on the symbols that are available to carry a port-5 URS overlap with CSI-RS resource elements from neighboring cells.

11. A system for allocating resource elements in an orthogonal frequency division multiplexed (OFDM) system for transmission of a channel state information reference signal (CSI-RS) without overlapping with resource elements allocated to a port-5 user equipment-specific reference signal (URS) signal, comprising:
a shifting unit configured to shift in a frequency domain at least a portion of resource elements allocated to the CSI-RS in a normal-CP subframe; and
a patterning unit configured to pattern resource elements in an extended-CP subframe in such a way that there is at least one CSI-RS reuse pattern with no resource element overlapping with the port-5 URS in the extended-CP subframe.

12. The system of claim 11, wherein the allocation of resource elements is defined per an 8-port CSI-RS, or per a group of eight CSI-RS resource elements, within a single physical resource block (PRB) whose time-domain dimension is one subframe and whose frequency-domain dimension is 12 subcarriers.

13. The system of claim 11, wherein for the normal-CP subframe, the CSI-RS resource element index ordering in each pattern is provided by at least one of time domain ordering and frequency domain ordering, and the location within the PRB of the i-th CSI-RS resource element, represented by (kᵢ,lᵢ), is given by lᵢ=l′+(i mod 2) for 0≦i<8 and
$${k}_{2 j} = {k}_{2 j + 1} = {k}^{′} - ( j mod 2 ) \times 6 - ⌊ \frac{j}{2} ⌋ + {Δ}_{j} for 0 \leq j < 4 ,$$
where (k′,l′) is the location of a CSI-RS resource element with a largest subcarrier index and smallest symbol index in each CSI-RS per-cell pattern, and Δⱼ is used to perform resource element shifting in frequency domain.

14. The system of claim 13, wherein Δⱼ can be one of following:
$${Δ}_{j} = 0 ;$$
$${Δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise ;\end{matrix} \\ or \\ {Δ}_{j} = \{ \begin{matrix}{δ}_{j} & 0 \leq r \leq 1 \\ ⌊ \frac{j}{2} ⌋ - ( {k}^{′} mod 3 ) + ( [ {k}^{′} - ⌊ \frac{j}{2} ⌋ + {δ}_{j} ] mod 3 ) & 2 \leq r \leq 3 ,\end{matrix} \\ where \\ {δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise\end{matrix}$$

15. The system of claim 11, wherein for the extended-CP subframe, the CSI-RS resource elements per cell are patterned within the PRB as pairs of CSI-RS resource elements located within the same two ODFM symbols at every third pair of subcarriers counting downward from a pair of CSI-RS resource elements with a largest subcarrier index on the two OFDM symbols in one PRB.

16. The system of claim 15, wherein the same two OFDM symbols where pairs of CSI-RS resource elements are allocated are symbol 4 and symbol 5 in either slot of one subframe.

17. The system of claim 15, wherein the largest subcarrier index of the pair of CSI-RS resource elements in one PRB is a value from {9,10}.

18. The system of claim 15, wherein the CSI-RS resource element index ordering in each pattern is provided by at least one of time domain ordering and frequency domain ordering, and the location within the PRB of the i-th CSI-RS RE, represented by (kᵢ,lᵢ), is given by lᵢ=l′+(i mod 2) for 0≦i<8 and k₂ⱼ=k₂ⱼ₊₁=k′−3×j for 0≦j<4, where (k′,l′) is the location of a CSI-RS resource element with a largest subcarrier index and smallest symbol index in each CSI-RS per-cell pattern.

19. The system of claim 12, wherein
any four CSI-RS resource elements with indices 0˜3 or 4˜7 in an 8-port CSI-RS resource element allocation are used for a 4-port CSI-RS allocation, and the choice between 0˜3 and 4˜7 is at least one of signaled by high-layer signaling and automatically determined by ƒ(N_{ID}^{cell})mod 2,
any two CSI-RS resource elements with indices (2j) and (2j+1) in an 8-port CSI-RS resource element allocation are used for a 2-port CSI-RS allocation, and the choice among four such pairs is at least one of signaled by high-layer signaling and automatically determined by ƒ(N_{ID}^{cell})mod 4, and
ƒ(N_{ID}^{cell}) is a function of cell identification, where ƒ(N_{ID}^{cell})=N_{ID}^{cell} or
$$f ( {N}_{ID}^{cell} ) = ⌊ \frac{{N}_{ID}^{cell}}{R} ⌋ ,$$
R being a reuse factor per subframe.

20. The system of claim 11, wherein for all resource elements overlapping one or more CSI-RS resource elements from neighboring cells:
overlapping resource elements on the symbols that are not available to carry a port-5 URS are muted, where the muting is performed on resource elements falling into symbols {5,8,11} per subframe, and
the resource elements on symbols that are available to carry a port-5 URS are not muted, even though the resource elements on the symbols that are available to carry a port-5 URS overlap with CSI-RS resource elements from neighboring cells.

21. The station of claim 11, wherein the station is a base station.

22. A non-transitory computer-readable medium storing instructions thereon for executing a method of allocating resource elements in an orthogonal frequency division multiplexed (OFDM) system for transmission of a channel state information reference signal (CSI-RS) without overlapping with resource elements allocated to a port-5 user equipment-specific reference signal (URS) signal, the method comprising:
shifting in a frequency domain at least a portion of resource elements allocated to the CSI-RS in a normal-CP subframe; and
patterning resource elements in an extended-CP subframe in such a way that there is at least one CSI-RS reuse pattern with no resource element overlapping with the port-5 URS in the extended-CP subframe.

23. The computer-readable medium of claim 22, wherein the allocation of resource elements is defined per an 8-port CSI-RS, or per a group of eight CSI-RS resource elements, within a single physical resource block (PRB) whose time-domain dimension is one subframe and whose frequency-domain dimension is 12 subcarriers.

24. The computer-readable medium of claim 22, wherein for the normal-CP subframe, the CSI-RS resource element index ordering in each pattern is provided by at least one of time domain ordering and frequency domain ordering, and the location within the PRB of the i-th CSI-RS resource element, represented by (kᵢ,lᵢ), is given by lᵢ=l′+(i mod 2) for 0≦i<8 and
$${k}_{2 j} = {k}_{2 j + 1} = {k}^{′} - ( j mod 2 ) \times 6 - ⌊ \frac{j}{2} ⌋ + {Δ}_{j} for 0 \leq j < 4 ,$$
where (k′,l′) is the location of a CSI-RS resource element with a largest subcarrier index and smallest symbol index in each CSI-RS per-cell pattern, and Δⱼ is used to perform resource element shifting in frequency domain.

25. The computer-readable medium of claim 24, wherein Δⱼ can be one of following:
$${Δ}_{j} = 0 ;$$
$${Δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise ;\end{matrix} \\ or \\ {Δ}_{j} = \{ \begin{matrix}{δ}_{j} & 0 \leq r \leq 1 \\ ⌊ \frac{j}{2} ⌋ - ( {k}^{′} mod 3 ) + ( [ {k}^{′} - ⌊ \frac{j}{2} ⌋ + {δ}_{j} ] mod 3 ) & 2 \leq r \leq 3 ,\end{matrix} \\ where \\ {δ}_{j} = \{ \begin{matrix}1 & {v}_{shift} = 0 , j ∈ \{ 1 , 3 \} \\ 1 & {v}_{shift} = 1 , j = 1 \\ - 1 & {v}_{shift} = 2 , j = 2 \\ 0 & otherwise\end{matrix}$$

26. The computer-readable medium of claim 22, wherein for the extended-CP subframe, the CSI-RS resource elements per cell are patterned within the PRB as pairs of CSI-RS resource elements located within the same two ODFM symbols at every third pair of subcarriers counting downward from a pair of CSI-RS resource elements with a largest subcarrier index on the two OFDM symbols in one PRB.

27. The computer-readable medium of claim 26, wherein the same two OFDM symbols where pairs of CSI-RS resource elements are allocated are symbol 4 and symbol 5 in either slot of one subframe.

28. The computer-readable medium of claim 26, wherein the largest subcarrier index of the pair of CSI-RS resource elements in one PRB is a value from {9,10}.

29. The computer-readable medium of claim 26, wherein the CSI-RS resource element index ordering in each pattern is provided by at least one of time domain ordering and frequency domain ordering, and the location within the PRB of the i-th CSI-RS RE, represented by (kᵢ,lᵢ) is given by lᵢ=l′+(i mod 2) for 0≦i<8 and k₂ⱼ=k₂ⱼ₊₁=k′−3×j for 0≦j<4, where (k′,l′) is the location of a CSI-RS resource element with a largest subcarrier index and smallest symbol index in each CSI-RS per-cell pattern.

30. The computer-readable medium of claim 23, wherein
any four CSI-RS resource elements with indices 0˜3 or 4˜7 in an 8-port CSI-RS resource element allocation are used for a 4-port CSI-RS allocation, and the choice between 0˜3 and 4˜7 is at least one of signaled by high-layer signaling and automatically determined by ƒ(N_{ID}^{cell})mod 2,
any two CSI-RS resource elements with indices (2j) and (2j+1) in an 8-port CSI-RS resource element allocation are used for a 2-port CSI-RS allocation, and the choice among four such pairs is at least one of signaled by high-layer signaling and automatically determined by ƒ(N_{ID}^{cell})mod 4, and
ƒ(N_{ID}^{cell}) is a function of cell identification, where θ(N_{ID}^{cell})=N_{ID}^{cell} or
$$f ( {N}_{ID}^{cell} ) = ⌊ \frac{{N}_{ID}^{cell}}{R} ⌋ ,$$
R being a reuse factor per subframe.

31. The computer-readable medium of claim 22, wherein for all resource elements overlapping one or more CSI-RS resource elements from neighboring cells:
overlapping resource elements on the symbols that are not available to carry a port-5 URS are muted, where the muting is performed on resource elements falling into symbols {5,8,11} per subframe, and
the resource elements on symbols that are available to carry a port-5 URS are not muted, even though the resource elements on the symbols that are available to carry a port-5 URS overlap with CSI-RS resource elements from neighboring cells.
